(19) United States
(12) Patent Application Publication
(10) Pub. No.: US 2006/0289439 A1
(43) Pub. Date: Dec. 28, 2006

(54) Food steamer with plurality of compartments

(76) Inventors: Samantha Dreimann, Lake Forest, IL (US); Guillaume Jean Since, Hong Kong (CN)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/384,742

(22) Filed: Mar. 20, 2006

Related U.S. Application Data
(60) Provisional application No. 60/663,907, filed on Mar. 21, 2005.

(51) Int. Cl. A21B 1/22; A21B 1/00; F27D 11/00

(52) U.S. Cl. 219/401

(57) ABSTRACT

A cooking device including a base having a water reservoir divided into a first region and a second region; a first heating element disposed within the first region to produce steam from water in the first region; and a second heating element disposed within the second region to produce steam from water in the second region. The cooking device further includes a first container disposed above the first region having a perforated floor to allow steam from the first region to enter the first container; and a second container disposed above the second region having a perforated floor to allow steam from the second region to enter the second container. A controller in the cooking device is configured to independently control the first and second heating elements.

This patent application claims priority to U.S. provisional application Ser. No. 60/663,907, filed Mar. 21, 2005, which is incorporated herein by reference in its entirety.

### BACKGROUND OF THE INVENTION

1. Technical Field

The invention relates to kitchen appliances generally and, in particular to a novel device for steaming a plurality of foods.

2. Related Art

Cooking food using steam is well-known. It is also well understood that different foods may require widely varied times to be appropriately cooked with steam. Thus, it has been difficult to prepare different foods with varied steam cooking times for the same meal. Accordingly, it is an object of the present invention to provide a device that can steam various foods in a single appliance.

### SUMMARY OF THE INVENTION

The present invention is a cooking device including a base having a water reservoir divided into a first region and a second region; a first heating element disposed within the first region to produce steam from water in the first region; and a second heating element disposed within the second region to produce steam from water in the second region. The cooking device further includes a first container disposed above the first region having a perforated floor to allow steam from the first region to enter the first container; and a second container disposed above the second region having a perforated floor to allow steam from the second region to enter the second container. A controller in the cooking device is configured to independently control the first and second heating elements.

The cooking device may further include a first timer operably associated with the first heating element for setting a steam time for a food in the first container, and a second timer operably associated with the second heating element for setting a steam time for a food in the second container. The controller is then configured to actuate the first and second heating elements based on the steam time set for the respective first and second timers. Preferably, the controller is also configured to actuate the first and second heating elements such that the steaming operation for each of the two containers completes simultaneously.

In another aspect, the present invention is a method for steaming at least two different foods in a cooking device having a water reservoir divided into first and second substantially thermally independent regions, and first and second containers disposed above a respective one of the first and second substantially thermally independent regions. The method includes receiving a first food in the first container; receiving a second food in the second container; setting a first steam time for the first food; setting a second steam for the second food; heating water in the first substantially thermally independent region according to the first steam time, whereby steam produced by heating the water in the first substantially thermally independent region steams the first food; and heating water in a second substantially thermally independent region according to the second steam time, whereby steam produced by heating the water in the second substantially thermally independent region steams the second food.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 shows a perspective view of one approach to a steamer according to the present invention.

FIG. 2 shows an exploded view of the steamer of FIG. 1.

FIG. 3 is a top plan view of the food containers from the steamer of FIG. 1.

FIG. 4 is a top plan view of the tray from the steamer of FIG. 1.

FIG. 5 is a top plan view of the base from the steamer of FIG. 1.

FIG. 6 is a block diagram of a control circuit for the steamer of FIG. 1.

### DETAILED DESCRIPTION OF THE EXEMPLARY EMBODIMENTS

Referring to the Figures, according to a preferred embodiment of the present invention, a steamer 100 is shown which includes a base 110, a draining/steam diffusion tray 120, a plurality of bowls 130a through 130c each having an associated lid 131a through 131c. Preferably, base 110 is constructed of heat-resistant plastic such that the base can withstand the temperature that is necessarily generated to produce steam. Similarly, bowls and lids 130a-c, 131a-c are also constructed of heat-resistant plastic. Unlike the base, however, it is preferred that the bowls and lids be formed from transparent plastic to allow the end user to view the food as it cooks.

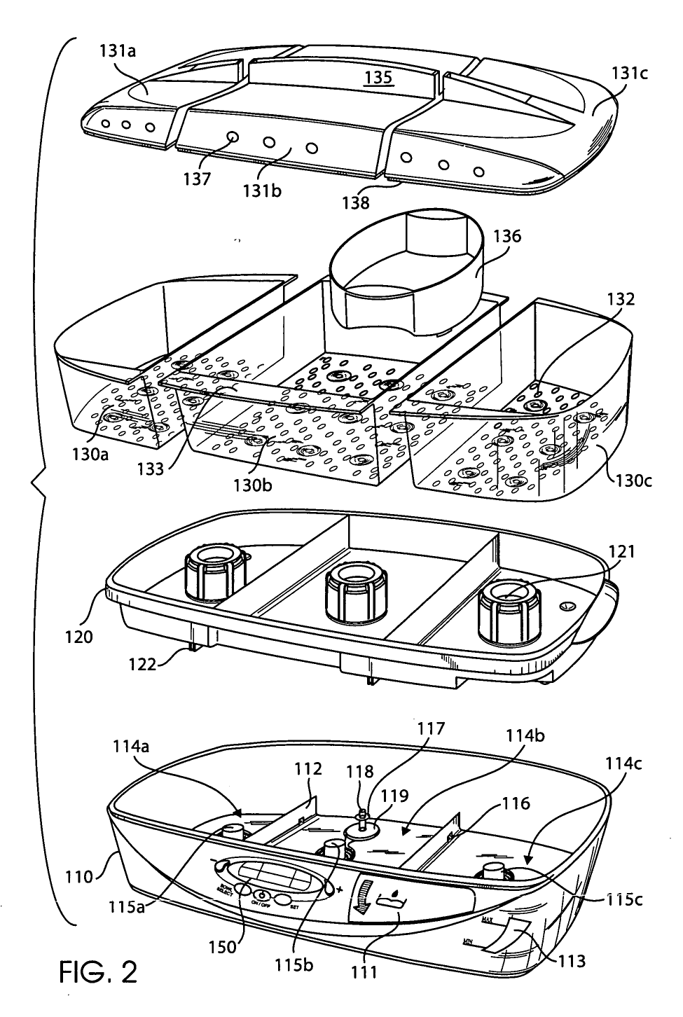

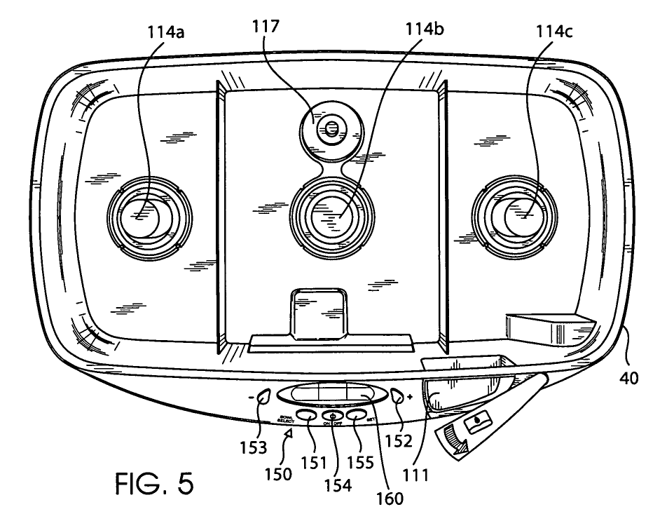

As shown in FIGS. 2 and 5, base 110 is a primarily hollow reservoir intended to contain water to produce the steam for cooking. The reservoir is substantially bifurcated into a plurality of considerably thermally independent regions 114a-c by diffusion tray support posts 112, such that the number of thermally independent regions will generally be equal to the number of bowls in steamer 100. Within each thermally independent region 114a-c of base 110 is an independently controllable heating element 115a-c.

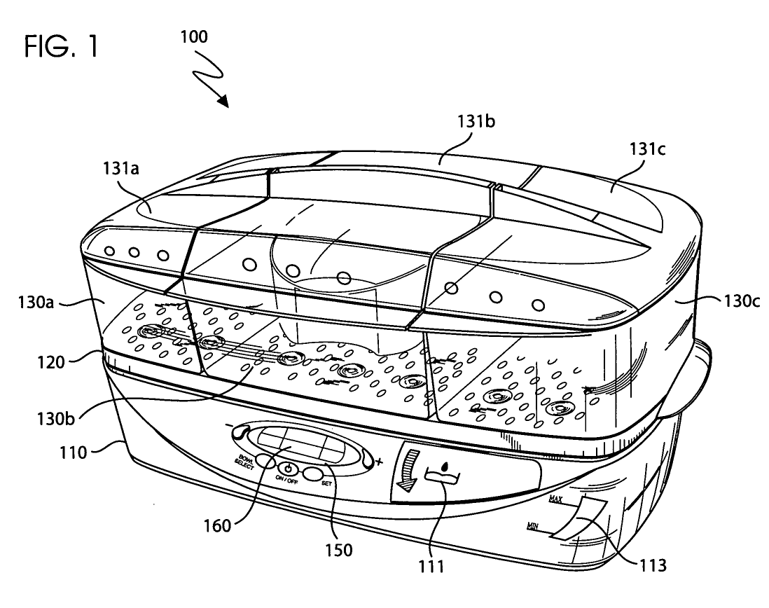

Water may be added to the base 110 via at least one water inlet 111. As shown in FIGS. 1, 2, and 5, the water inlet 111 may be an aperture in an upper portion of the base 10 that is covered to substantially preclude the emission of steam from the inlet and to minimize the possibility of inadvertently contaminating the water in the base 110.

It should be understood that where the base includes only one water inlet there must be some fluid communication between the considerably thermally independent regions. For example, as shown in FIG. 2, fluid communication between the thermally independent regions may be performed via small notches 116 along the lower portion of the support posts 112. As a result, water added via water inlet 111 is distributed to each of the thermally independent regions 114a-c. Notches 116 also allow water to move between the thermally independent regions during use such that the water level throughout the entire base remains relatively constant even if only one region is being used for cooking. Of course, each region may alternatively have its own water inlet in order to limit the exchange of liquid between the thermally independent regions.

The base 10 may also (or alternatively) include water level detector 117 to detect the amount of water present in the base. As shown in FIGS. 2 and 5, the water level detector 117 may be formed of a cylindrical rod 118 protruding from the floor of the base 10. A circular disc 119 may then be slidably positioned around the cylindrical rod such that the disc can move vertically along the rod 118. The disc 119 is constructed of a material that floats in water. As the water level increases or decreases, the disc moves up or down along the rod 118, respectively. A sensor (not shown) then detects the position of the disc 119 along the rod 118. When the disc reaches a predetermined level indicative of an amount of water that is inadequate for maintaining a sufficient amount of steam for cooking, the steamer 100 may be configured to automatically shut off. Additionally, the steamer may also provide a signal to the user to add more water. This signal, for example, may be in the form of a visual signal on the base 10, an audible signal, or both.

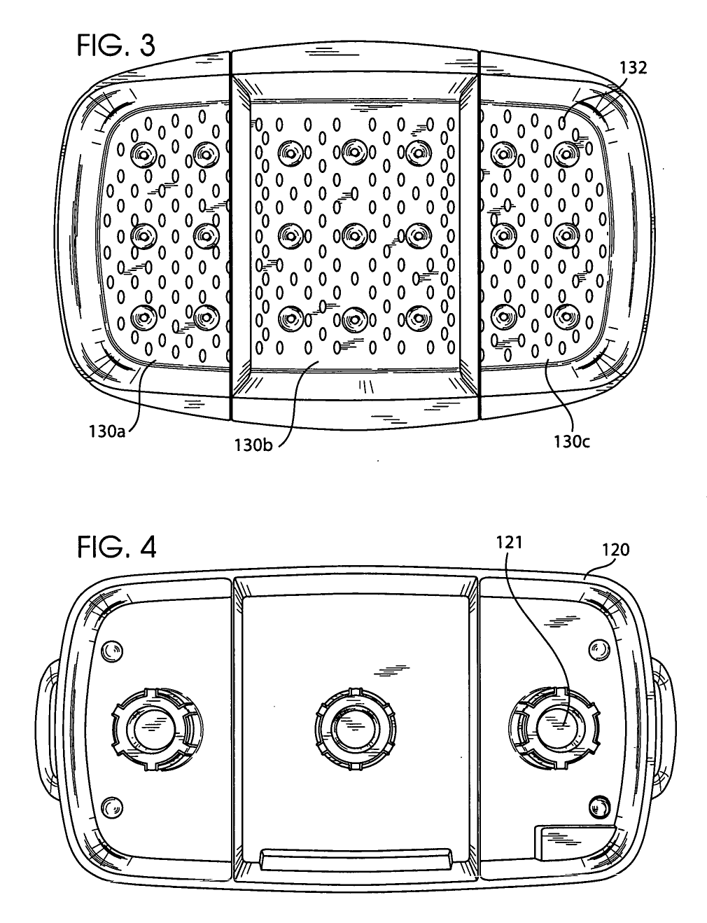

The base 10 may also include a water level indicator 113 to identify the proper level of water needed for operation of the steamer to permit a user to manually inspect the amount of water present in the base. As shown in FIG. 3, the water level indicator preferably identifies both a maximum and a minimum level of water. While the Figures depict only a single water level indicator 113, it should be understood that where the regions are completely independent, a separate water level indicator may be associated with each region.

In one embodiment, an inner liquid compartment (not shown) may also be added to each section of the base 110 for holding an infusing liquid to be infused into the food placed in the bowl associated with that region of the base 110. The heat from the steam generated in base 110 may volatilize the infusing liquid causing it to be delivered to the food in the bowl. The infusing liquids may also be carried by the force of the rising steam into the bowl.

The base 110 may also have feet disposed at various points on its bottom to lift the bottom surface of the base off of the countertop to minimize potential damage from the heat of the water and heating elements used to make the steam.

As best shown in FIGS. 1, 2 and 5, base 110 further includes a control panel 150. In the depicted embodiment, the control panel 150 includes an LCD element 160 and a plurality of switches 151-155 to provide for user input to control the steamer 100. While various names and functions have been assigned to the exemplary switches in the Figures, these are solely for illustrative purposes.

As shown, the switches 151-155 may be momentary contact switches, but other types of switches such as toggle switches may be used. In one embodiment, steamer 100 may be initialized by plugging the unit into a source of power, such as a wall outlet. Alternatively, an on/off switch 154, may be provided. Once steamer 100 has been actuated, the end user would press the “BOWL SELECT” button 151 until the desired bowl was indicated on the LCD element 160 as being selected. In the present embodiment, LCD element 160 is divided into three sections corresponding to the three bowls 130a-c. By pressing the “+” and “−” buttons, 152, 153, respectively, the end user manually sets the timer corresponding to the selected bowl 130a-c by choosing the desired steam time for the food that the end user intends to place in the selected bowl. After setting the time for the first bowl, the end user may then press the “BOWL SELECT” button 151 again to select the timer for the next bowl 130 for programming. Once the user has programmed the desired time for each bowl and placed the desired food in each respective bowl, the end user would press “SET” button 155, starting the steaming operation as described below.

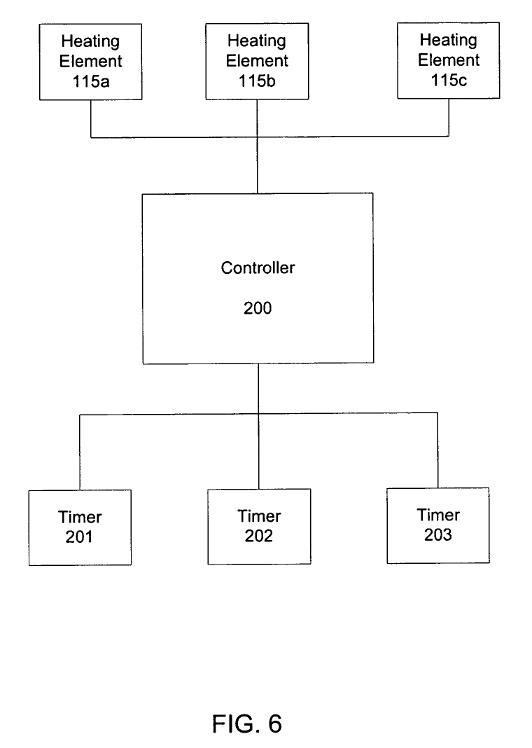

As shown in FIG. 6, each of the timers 201, 202, and 203 programmed with desired steam times by the end user may be in communication with a controller 200, which is preferably a processor under the control of firmware. The controller 200 uses the steam times set in the timers 201, 202, and 203 to schedule the steaming operation for each bowl 130a-c and control the heating elements 115a-c such that all of the steam cycles are completed simultaneously. For example, if bowl 130a contains chicken requiring 120 seconds of steam; bowl 130b contains white rice requiring 300 seconds of steam; and bowl 130c contains carrots requiring 180 seconds to be completed, then the processor would actuate heating element 115b associated with the white rice first. One hundred and twenty seconds after actuating heating element 115b, the processor would actuate heating element 115c (carrots) and finally sixty seconds later the processor would actuate heating element 115a (chicken). At the completion of the steaming cycle an audible and/or visual indication that the steaming cycles have been completed as programmed may be provided.

In one embodiment, the user may manually set the cooking time for the food in each bowl manually. Alternatively, cooking times may also be preprogrammed into the steamer 100 such that the steamer may automatically set the cooking time upon the user identifying the specific type of food in the bowl.

As shown in FIGS. 2 and 3, bowls 130a-c each have a perforated floor to allow steam to enter from and condensed water to return to the associated reservoir in the base 110. The associated lids 131a-c may also include an overlapping lip 138 that facilitates the return of the condensed water back to the base 110. The lip 138 between the lid and the side wall of each bowl may substantially minimize scalding accidents by directing more of the hot water back toward the bottom. By recycling water in this manner, the water reservoirs in the base 110 will not require additional water as often. The lids 131a-c may also include small apertures 137 to allow some excess steam to escape from the bowls during use. As shown in FIG. 2, bowls 130 may include an integral gripping surface 133 and lids 131 may also include handles 135.

An additional bowl 136 may also be provided having a solid rather than perforated floor. The additional bowl 136 is preferably size to fit within at least one of the bowls 130a-c without covering the entirety of the perforated floor of the respective bowl in which it is placed. The additional bowl 136 thus allows a user to use food in the steamer that is not completely solid and thus could otherwise leak through the perforated floor of the bowls 130a-c.

Draining/steam diffusion tray 120 is preferably a unitary component, which has some advantage in that tray 120 holds the separable bowls 130a-c together and may provide a more stable platform for loading and unloading the bowls. The diffusion tray 120 includes diffusers 121 that diffuse the steam produced in the reservoir to more evenly cook the foodstuffs. It is also contemplated that the diffusers may have mechanical closing mechanisms (not shown) to preclude the loss of steam to adjacent, unused steam bowls when only one steam bowl is in use. As illustrated in FIG. 2, tray 120 may include a plurality of legs 122 that rest in a corresponding diffusion tray support post 112, which each rise up from the bottom of base 110. Additionally or alternatively, the tray 120 may also be supported about its periphery by the outer edge of the base 110.

While various embodiments of the application have been described, it will be apparent to those of ordinary skill in the art that many more embodiments and implementations are possible that are within the scope of this invention. For instance, the number of bowls and associated lids is a matter of design choice. Similarly, the size and shape of the bowls and associated lids is also a matter of design choice.

What is claimed is:

1. A cooking device comprising:
a base having a water reservoir divided into a first region and a second region;
a first heating element disposed within the first region to produce steam from water in the first region;
a second heating element disposed within the second region to produce steam from water in the second region;
a first container disposed above the first region, the first container having a perforated floor to allow steam from the first region to enter the first container;
a second container disposed above the second region, the second container having a perforated floor to allow steam from the second region to enter the second container; and
a controller to independently control the first and second heating elements.

2. The cooking device of claim 1 further including a first timer operably associated with the first heating element for setting a steam time for a food in the first container; and a second timer operably associated with the second heating element for setting a steam time for a food in the second container.

3. The cooking device of claim 2 wherein the first and second timers are manually settable.

4. The cooking device of claim 2 further including a user interface for manually setting the first and second timer.

5. The cooking device of claim 2 wherein the first timer is capable of being set to a steam time that is different from a steam time set for the second timer.

6. The cooking device of claim 2 wherein the controller is configured to actuate the first and second heating elements based on the steam time set for the respective first and second timers.

7. The cooking device of claim 6 wherein the controller is configured to actuate the first and second heating elements such that the steaming operation for each of the two containers completes simultaneously.

8. The cooking device of claim 1 further including a water inlet through which water may be added to the base.

9. The cooking device of claim 1 wherein the first and second regions are substantially thermally independent from one another.

10. The cooking device of claim 1 further including a lid associated with the first container, the lid having a lip positioned between the lid and a sidewall of the first container when the lid is closed to direct condensed water from the lid to the base.

11. The cooking device of claim 1 further including a tray for holding the first and second containers in the cooking device.

12. The cooking device of claim 1 1 wherein the tray includes a diffuser to diffuse steam produced in at least one of the first and second regions.

13. The cooking device of claim 1 further including a sensor for determining a water level in the base.

14. A cooking device comprising:
a base having a water reservoir divided into two substantially thermally independent regions;
two independently controllable heating elements, each operably disposed within a respective one of the two considerably thermally independent regions for producing steam from water disposed in the water reservoir;
two containers, each of the two containers being operably disposed above a respective one of the two considerably thermally independent regions and each container having a perforated floor to allow the steam from the respective one of the two considerably thermally independent regions to envelope food contained within the container;
two manually settable timers, each timer being operably associated with one of the two independently controllable heating elements; and
a controller for actuating the two independently controllable heating elements based on the time into each of the two manually settable timers such that the steaming operation for each of the two containers completes simultaneously.

15. A method for steaming at least two different foods in a cooking device having a water reservoir divided into first and second substantially thermally independent regions, and first and second containers disposed above a respective one of the first and second substantially thermally independent regions; the method comprising:
receiving a first food in the first container;
receiving a second food in the second container;
setting a first steam time for the first food;
setting a second steam for the second food;
heating water in the first substantially thermally independent region according to the first steam time, whereby steam produced by heating the water in the first substantially thermally independent region steams the first food; and
heating water in a second substantially thermally independent region according to the second steam time, whereby steam produced by heating the water in the second substantially thermally independent region steams the second food.

16. The method of claim 15 further including sequencing the heating of water in the first and second substantially thermally independent region based on the first and second steam times.

17. The method of claim 15 further including sequencing the heating of water in the first and second substantially thermally independent region based on the first and second steam times such that the steaming operation for each of the first and second containers completes simultaneously.

18. The method of claim 15 wherein setting a first steam time includes manually setting the first steam time; and setting a second steam includes manually setting the second steam time.
